(19) United States
(12) Patent Application Publication
(10) Pub. No.: US 2010/0303551 A1
(43) Pub. Date: Dec. 2, 2010

(54) Decontamination of sediments through particle size reduction and stabilization treatment

(76) Inventor: YUN-FENG CHANG, Houston, TX (US)

Correspondence Address: DR. YUN-FENG CHANG, 4443 STERLING WOOD WAY, HOUSTON, TX, 77059, US

(21) Appl. No.: 12/455,044

(22) Filed: May 28, 2009

(51) Int. Cl. E02D 31/00; C09K 3/00; A62D 3/00; C05F 7/00; A01N 25/00

(52) U.S. Cl. 405/229; 252/182.11; 252/182.35; 252/182.32; 106/638; 588/400; 71/25; 504/116.1; 424/489

(57) ABSTRACT

A process of decontamination of sediment particles to reduce active pollutant components through particle size reduction and stabilization treatment.

### FIELD OF THE INVENTION

The present invention relates to processes for forming a mixture of sediment, and more particularly to processes for forming a mixture of sediment particles having reduced particle size to achieve better mixing and reaction with stabilizing agent to decontaminate sediment particles.

### BACKGROUND OF THE INVENTION

Improvement in quality of life of many parts of world goes beyond basic needs, for instance, food, water and shelter. People become more and more concerned about the quality of environment they live in. Visible and easily recognizable pollutions, like smog, haze, dust, noise, odor, toxic wastes are highly regulated and monitored. However, some other form of pollutions, for instance, high levels of metals, particularly, heavy metals in sediments and soils have not received equal attentions. Impact of these less visible or recognizable pollutants is far more reaching and detrimental to the health and quality of life of people live close by the contaminated sites. There are a large number of these sites that are not only substantial in size, but also in terms of extent of pollution, their close proximity to community, and the toxicity of the pollutants. Among the most concerned elements are, for example, mercury and arsenic because of their high toxicity. Treatment of these sites is mandated by local government or state government in many parts of world to reduce or eliminate the negative impact. Therefore, there is a strong demand for technologies or methodologies to achieve economic treatment of polluted soils and sediments.

### DESCRIPTION OF THE INVENTION

The present invention provides a method of treating massive pollution sites to achieve high decontamination efficiency (high reduction in active pollution form) that is unmatched by prior arts. It is achieved through particle size reduction and use of stabilization agents.

“Sediments” refer to materials collected at the subsurface of a waste water containment pond, reservoir, or site. They consist of solids waste present in the waste water stream, or materials formed due to change of temperature, of pH, of concentration of ionic species, and change of composition, or introduction of certain solid particles, or reaction of soluble species from different streams or from the same steam but formed at different time. Sedimentation occurs on the time scale of hours, days, sometimes, weeks, months, even years depending on concentration and composition of the species present in the system. Presence of multi-valent cations and anions, for example Al³⁺, Ca²⁺, SO₄²⁻, S²⁻, PO₄³⁻ could resulted in accelerated sedimentation. Introduction of solids particles can also lead to significant enhancement in sedimentation rate, for example, dust particles fallen into the waste stream or water body, debris of plants, or residue of animal or insects, soil particles, clay, silt, or sludge. Introduction of high molecular weight organics and colloidal particles both charged and non-charged can also result in significant changes in formation of sediments. Thickness and density of sediment layer varies with waste water stream composition, change of temperature, solids content and presence of other sedimentation active species. Higher solids content and fast settling rate can lead to denser sediment layer while slow sedimentation and low solids content tend to give lower density of sediment layer. Sediment layer thickness varies from a fraction of an inch to inches and even feet depending on the duration of sedimentation and solids content of waste water stream.

“Waste water stream” refers to any water stream that contains undesirable components either soluble or non-soluble, both organic and inorganic. Waste water stream can be produced from chemical plants, petrochemical plants, paper making, food industry, pharmaceutical industry, leather processing, pigment industry, caustic plants, mining, mineral processing, and semiconductor industry. Types of contamination can be classified into (1) heavy metals or toxic elements, for example, mercury, cadmium, chromium, antimony, manganese, arsenic, selenium, silver, zinc, copper; (2) carcinogens, for example, polynuclear aromatics (PNA), organochlorides, particularly, multi-chlorinated benzenes or bi-phenyls; (3) fine solid particles that are toxic. The fine solids particles can be inorganic or organic or combination of both. Due to their small size and high surface area and their affinity to smaller molecules or ionic species, they act as the carrier of many harmful compounds or components. Concentration of heavy elements varies from a fraction of weight part per million (ppm) to hundreds and sometimes a few thousands of part per million. Organic contents change from many ppms to a few percentage point of the total sediment.

“Particles” refer to materials carried in waste water stream, precipitation or settlement of particles newly formed from the corresponding soluble species, or agglomeration, assembly of smaller particles, adsorption of soluble species onto particles to make the original particles bigger or make agglomeration or reorganization easier. Particles size ranges from tens of nanometers to microns, even to millimeters. Some debris can be in centimeters.

“Particle size distribution (PSD)” describes the relative proportion of individual particle size. For sedimentation samples, it often refers materials based on their particles sizes as sand, silt and clay. Sand is the largest particles 0.05-2.0 mm, silt is intermediate in size, 0.002-0.05 mm (2-50 microns), while clay is the smallest <0.002 mm (<2 microns), particles greater than 2.0 mm are generally called stones, rocks, or gravels are not regarded as soil materials. Particles smaller than one micron are also called colloidal particles. Brownian motion is a characteristics of a colloidal particle and the size range is 1 nm to 100 nm, while others have defined colloidal particles being in the range from 5 nm to 500 nm (see J -E. Otterstedt and D. A. Brandreth, Small Particles Technology, Plenum Press, New York, 1998, p. 8). Particles above 500 nm or 0.5 micron in size settle from water in a matter of days, but if they are less than 70 nm, they do not settle under gravity because of Brownian motion keeps them in suspension.

Particle size or particle size distribution (PSD) are obtained by well known techniques like (1) sedigraph, for example, Micromeritics SediGraph 5000E, SediGraph 5100 based on particle sedimentation measured by x-ray, it measures particles in the range of 0.5-250 microns; (2) laser scattering, which measures light scattering by particles, particularly small particles, for example, Horiba LA910, Microtrac S3500, measuring particles in the range of 10 nm to 3000 microns; (3) acoustic and electro-acoustic techniques, for example, Matec ESA 9800, Matec AZR-Plus, and Dispersion Technologies DT-1200, measuring particles in the range of 30 nm to 300 microns; (4) ultracentrifugation, in particular, disc centrifuge, for example CPS Instruments DC2400, measuring particles from 5 nm to 75 microns; (5) electroresistance counting method, an example of this type is the Coulter counter, which measures the momentary changes in the conductivity of a liquid passing through an orifice that takes place when individual non-conducting particles pass through. The particle count is obtained by counting pulses, and the size is dependent on the size of each pulse; (6) high sensitivity electrophoretic laser scattering technique, like Brookhaven Instruments ZetaPals and ZetaPlus, measuring particles of 3 nm to 10 microns; (7) electron microscopic imaging, scanning electron microscopy (SEM) and transmission electron microscopy (TEM) can determine both particle size and morphology. Under ideal conditions, particles as small as 1-2 nm to as big as 1 mm can be measured; (8) optical microscopy, it can measure particle size from 1 micron to 10 mm. For sediment samples, particle sizes to be analyzed range from a few nanometers to a few millimeters. Often time, more than one technique is required to get the full distribution. More comprehensive dealing of particle size measurements using light scattering can reference the book, “Particle Characterization: Light Scattering Method”, by Renliang Xu, Kluwer Academic Publisher, Dordrecht, The Netherlands, pp. 1-24, 2000. More generic treaty of fine particle characterization can reference monograph “Analytical Methods in Fine Particle Technology”, by P. A. Webb and C. Orr, Micromeritics Instrument Corp., Norcross, Ga., pp. 17-28, 1997. More comprehensive dealing of particle characterization and preparation can reference the book by J-E. Otterstedt and D. A. Brandreth, “Small Particles Technology”, Plenum Press, New York, p. 8, 1998; and book by A. M. Spasic and J-P. Hsu, “Finely Dispersed Particles: Micro-, Nano-, and Atto-Engineering”, Taylor & Francis, Roca Raton, pp. 329-340, 2006.

The “dₛ” particle size for purposes of this patent application and appended claims means that s percent by volume of the sediment particles have a particle diameter no greater than the dₛ value. The “median particle diameter” is the d₅₀ value for a specified plurality of sediment particles. Typically, d₁₀, d₅₀, and d₉₀ are used to describe particle size and its distribution. d₅₀ is the average particle size, d₁₀ provides a measure of if fine particles are abundant in the sample, while d₉₀ gives a measure of whether over-sized particles are abundant or not.

“Particle diameter” as used herein means the diameter of a specified spherical particle or the equivalent diameter of non-spherical particles as measured by laser scattering using a Brookhaven ZetaPlus or Microtrac Model S3500 particles size analyzer or by disc centrifuge technique using CPS Instruments DC24000.

“Decontamination” herein is referred to reduction in degree of negative impact caused by active pollutants present in the contaminated and to be treated targets. It is achieved by reduction or elimination of active polluting form through transformation or chemical reaction to convert the pollutant element or species from an active form to an inactive form. It differs from other remediation techniques like, physical separation or containment. In the latter case, pollutants are not removed or transformed but rather stay intact. The containment provides a physical isolation and a barrier that reduce the immediate impact of the pollution. However, the toxic materials remain a source of pollution, and possess long term risk, from breakdown of the containment or physical barrier or any sabotage.

“Active pollutant form” is referred to forms of a pollutant that is determined by a protocol that is established or published by a local or state or federal government agency. This protocol allows quantification of amount of a given pollutant in samples obtained from a contaminated site. The sample can be in the form of liquid, solid or gas, sometimes, a combination of two or more than two. Quantity of the active pollutant form determined by the protocol is used to evaluate degree of pollution, and extent of decontamination when a treatment is carried out.

One such protocol is given in Table 1. It calls for an extraction procedure to determine the amount of element (pollutant) that is effective in causing harm in sediment samples. This amount is different from the total quantity of such element. For example, if a sample contains 100 ppm of element X in the form of active or extractable form, upon decontamination treatment, it reduces the amount of the active form or extractable form to 50 ppm while the total amount remains the same, then the treatment has achieved a 50% decontamination efficacy. If treatment Y is more effective in decontamination then treatment Z, then Y should give a higher decontamination efficacy than treatment Y. Likewise, two contaminant sites, M and N, both have the same levels of contaminants, or the same total amount of element L, but M has M′ amount of active L, and N has N′ amount of active element L, if M′>N′, then site N has a lower degree of potency causing harm to its surroundings, or it is less polluting. This particular procedure, method HJ-T299-2007 is designed to determine the amount of extractable or leachable pollutions in solid wastes, recycled materials, and soil samples for both inorganic and organic pollutants. It simulates the worse case scenario in leaching of pollutants out of the stored solid wastes, remediated wastes or re-claimed, or polluted soil by subjecting the target to a diluted acid mixture of sulfuric acid and nitric acid at weight ratio of 2 to 1 of the two acids. The diluted acids are to mimicking acid rains. It is published by the Chinese Academic Press. It took into effect on May 1, 2007. It is issued by the Chinese Bureau of Environmental Protection. This method is equivalent to the Toxicity Characteristic Leaching Procedure (TCLP) of the US Environmental Protection Agency (EPA). It consists of (1) an initial separation of liquid and solid phases; (2) particle size reduction of monolithic materials; (3) batch-wise extraction (using a rotary apparatus) of the solid phase with a simulated leaching fluid (leachant) for an 18-hour period; (4) separation of the liquid and solid phases, resulting in a liquid extract; (5) combining the extract (leachate) with any original liquid phase; (6) analysis of the combined sample for target constituents. Details from a 1999 public hearing on the original development of TCLP are presented by Kimmell. Leaching procedures were also developed for particular situations or applications, for example, the synthetic precipitation leaching characteristic by Shieh of the Florida Institute of Technology for tire wastes.

“Treatment” of a polluted site or material, or decontamination can be done either on site (in-situ) or off site (ex-situ) or combination of both depending on scale of treatment, location of the sites, ultimate goal of the treatment. In-situ treatment is typically lower cost than ex-situ treatment. In-situ treatment also reduces potential pollution caused by relocation or transportation of the polluted materials. However, in some cases, due to availability of treatment establishment or facility at off-site location, difficulties in setting up treatment facility on-site or due to lack of scale-of-economics on-site, off-site treatment may be a better option.

“Stabilizing agent” refers to chemicals or materials added to the sediment slurry during mixing and milling that reacts with pollutants to form a less reactive form of pollutants. Stabilizing agents can be selected from sulfur containing compounds or materials, for example, metal sulfides, metal hydrogen sulfides, disulfides, elemental sulfur, or sublime sulfur, or metal oxides, natural or synthetic clay, natural or synthetic zeolites, carbon blacks, charcoals, fine particles of refractory materials, spent or shredded tire, spent or recycled polymer materials or composite, cement powder, limestone, lime, gypsum, sea shells, fly ash, as well as residue or byproducts from many manufacturing processes.

In one embodiment, decontamination is achieved by reacting active polluting form with a stabilizing agent to convert the active polluting form into an inactive form. One example is that an extractable form of mercury or soluble form of mercury is converted into a non-extractable or less-extractable mercury form or less soluble form. More specifically, Hg²⁺ reacting with a sulfide source to give HgS which has very low aqueous solubility.

In one embodiment, an efficient decontamination solution is provided by particle size reduction of the contaminant particles.

Pollutants in sediments can be present in many different forms, ranging from solid particles of extractable form, ionic species adsorbed on surfaces or pores of particles, soluble form in water that is associated with the sediments. Due to this heterogeneity in form and wide variation in particles size, ranging from colloid particles to micron sized particles or larger particles in tens to hundreds of microns, it can be a real challenge to achieve complete conversion or reaction. Any incomplete conversion or transformation would result in lower decontamination efficiency. Therefore, a thorough and complete homogenization is required to achieve high decontamination efficiency.

From reaction kinetics point of view, for a given particle, reaction between pollutant and stabilizing agent occurs first at the outer layer, then progresses into the interior. Pollutant present inside a large particle would require a longer reaction time to be converted to an inactive form since the stabilizing agent has to penetrate through the outer layer. Transportation or diffusion of reactant through a solid layer meets with high resistance, making it very difficult to achieve high decontamination efficiency for large contamination particles. Therefore, it is critical to have smaller particle size to achieve high treatment efficiency.

Reduction in particle size not only enables higher degree of decontamination but also make treatment possible for many processes that otherwise taking an unrealistically long time to treat.

In one embodiment, particle size reduction has led to reduction of treatment time by at least 5% while achieving the same degree of decontamination.

In another embodiment, particle size reduction has led to reduction of treatment time by at least 8% while achieving the same degree of decontamination.

In yet another embodiment, particle size reduction has led to reduction of treatment time by at least 10% while achieving the same degree of decontamination.

In one embodiment, particle size reduction has led to an increase in treatment efficiency by at least 5%. In other words, if the treatment efficiency is 60% without particle size reduction, upon particle size reduction, the treatment efficiency has increased to 63%.

In another embodiment, particle size reduction has led to an increase in treatment efficiency by at least 8%. In other words, if the treatment efficiency is 60% without particle size reduction, upon particle size reduction, the treatment efficiency has increased to 64.8%.

In yet another embodiment, particle size reduction has led to an increase in treatment efficiency by at least 10%. In other words, if the treatment efficiency is 60% without particle size reduction, upon particle size reduction, the treatment efficiency has increased to 66%.

In one embodiment, particle size reduction and homogenization is achieved by a particle size reduction process, or milling process. Milling is carried out on a slurry or suspension of sediment materials, optionally with stabilizing agent, dispersant or dispersion aid, surface modifiers, solidification agent.

“Slurry or suspension” is referred to a mixture of polluted sediments and a dispersing agent, for example, water, and stabilizing agent or other additives to form a suspension or slurry. The water introduced can be fresh water, or water co-present in the pollution site or other waste water stream.

“Solids content” of the slurry or suspension is defined as the amount of solids particles or residue left after a treatment at elevated temperature to drive off water, or any other volatiles, or combustion to burn off organics. For example, treatment of sediment sample at 550° C. for 2 hours in air resulted in a residue whose mass is 40% of the original mass, that is the solids content of this sediment sample is 40 wt %. The solids content is collection of sediment particles, and other introduced materials for example stabilizing agents or additives.

In one embodiment, a dispersant is used in the decontamination process.

“Dispersant or dispersion aid or surface modifier” refers to a class of components or chemicals that their addition in a small amount to a slurry or suspension can result in a significant improvement in dispersion, that is (1) increased rate of breakdown of large lumps, (2) better wetting of dry particles or powder introduced into the slurry or suspension; (3) reduced viscosity. These changes or improvements are closely related to alteration in surface properties, surface charge, charge density or zeta potential. Detail list of different types of surface modifier or surfactants can be found in “Surfactants and Interfacial Phenomena”, Chapter 1, 3^{rd} Edition, by M. J. Rosen, John Wiley & Sons, Hoboken, N.J., 2004. They include, ionics, cationic, anionic, and zwitterionic; and non-ionics.

Zwitterionics contain both an anionic and a cationic charge under normal conditions, for example molecules containing a quaternary ammonium as the cationic group and a carboxylic group as the anionic group. For ionic surface modifiers the higher the charge density the more effective in surface modification. For example, according to Patton (T. C. Patton, Paint Flow and Pigment Dispersion—A Rheological Approach to Coating and Ink Technology, 2nd Edition, John Wiley & Sons, New York, p. 270, 1979), efficacy of cations or anions in surface modification increased from monovalent to divalent to trivalent in a ration of 1:64:729.

Non-ionic surface modifiers are polyelthylene oxide, polyacrylamide (PAM), partially hydrolyzed polyacrylamide (HPAM), and dextran.

Anionic surface modifiers include, carboxylate, sulfate, sulfonate and phasphate are the polar groups found in anionic polymers. Examples of water soluble anionic polymer are: dextran sulfates, high molecular weight ligninsulfonates prepared by a condensation reaction of formaldehyde with ligninsulfonates, and polyacrylamide. Commercially available anionic water soluble polymers include polyacrylamide, CYANAMER series from Cytec Industries Inc., West Paterson, N.J., like, A-370M/2370, P-35/P-70, P-80, P-94, F-100L & A-15; CYANAFLOC 310L, CYANAFLOC 165S.

Cationic surface modifiers: The vast majority of cationic polymers are based on the nitrogen atom carrying the cationic charge. Both amine and quaternary ammonium-based products are common. The amines only function as an effective surface modifier in the protonated state; therefore, they cannot be used at high pH. Quaternary ammonium compounds, on the other hand, are not pH sensitive. Ethoxylated amines possess properties characteristic of both cationic and non-ionics depending on chain length. Examples of water soluble cationic polymers are: polyethyleneimine, polyacrylamide-co-trimethylammonium ethyl methyl acrylate chloride (PTAMC), and poly(N-methyl-4-vinylpyridinium iodide. Commercially available materials include: Cat Floc 8108 Plus, 8102 Plus, 8103 Plus, from Nalco Chemicals, Sugar Land, TX; polyamines, Superfloc C500 series from Cytec Industries Inc., West Paterson, N.J., including C-521, C-567, C-572, C-573, C-577, and C-578 of different molecular weight; poly diallyl, dimethyl, ammonium chloride (poly DADMAC) C-500 series, C-587, C-591, C-592, and C-595 of varying molecular weight and charge density, and low molecular weight and high charge density C-501.

Zwitterionics: Common types of zwitterionic compounds include N-alkyl derivatives of simple amino acids, such as glycine (NH₂CH₂COOH), amino propionic acid (NH₂CH₂CH₂COOH) or polymers containing such structure segments or functional group.

“Solidification agent” refers to a chemical or substance that its introduction to a slurry or suspension can lead to hardening of the slurry or suspension, or can result in significant reduction in time required to achieve hardening or solidification. Typical solidification agent includes but not limited to cement, for example, Portland cement, cement clinker, gypsum, metakaolin, and other binder materials.

Solidification is desired in certain treatment scenarios because it can lead to a solid treated product in a short period of time.

In one embodiment, an encapsulation process is provided.

A highly recognized utility of solidification is its ability to form a barrier to separate pollutants and the surroundings of solidification is carried out. If applied correctly, especially in ample amount, it is possible to achieve encapsulation of pollutants.

Encapsulation of pollutants by a solidification agent has the potential to substantially reduce pollution if the encapsulation layer is dense and free of cracks making transportation of pollutant very slow. However, potential risk associated with breakdown of the barrier layer or developing cracks or holes in the barrier layer remains high if the pollutants are simply contained not treated.

In one embodiment, solids content of the slurry to be treated by milling is at least 1 wt %. It is more preferred that the solids content is at least 2 wt %. It is even more preferred that the solids content is at least 3 wt %, and it is most preferred that the solids content is at least 4 wt %.

Known milling techniques include but not limited to ball milling, roller milling, sonication, high-shear milling, and medium milling.

In one embodiment, milling is achieved by using a high-shear mixer or mill or a medium mill or mixer or combination of both.

It is preferred that after milling particle size d₅₀ or average particle size is reduced by at least 10% from for example 20 microns to 18 microns. It is even more preferred that after milling, d₅₀ is reduced by at least 15% from for example 20 microns to 17 microns. It is most preferred that after milling d₅₀ is reduced by at least 20% from for example 20 microns to 16 microns.

It is recognized that to maximize milling throughput and efficiency a high solids content slurry is desired. However, it is also recognized that slurries having high solids content often encounter high viscosity making them difficult to homogenize, difficult to transport and even more difficult to be milled. Therefore, it is highly desired to have a process that is capable of handling high solids content slurries.

In one embodiment, transportation means that can handle high solids materials, for example, a positive displacement pump is used to carry out slurry transportation from the mixing tank to the mill, for example, Moyno 1000 pump from Moyno Inc., Springfield, Ohio.

In one embodiment, a modifier is added to the slurry so that slurry viscosity can be significantly reduced. It is preferred that the surface modifier added can lead to reduction in slurry viscosity by at least 5%, that is from for example 50,000 cps to 47,500 cps, more preferred by at least 10%, that is from for example 50,000 cps to 45,000 cps, and most preferred by at least 15%, that is from for example 50,000 cps to 42,500 cps.

In one embodiment, the modifier is an ionic additive or water soluble polymer or dispersing regent selected from inorganic acids, low molecular weight organic acids, polyacids, cationic and anionic water soluble polymers.

In another embodiment, the amount of stabilizing agent added is at least 30 parts per million by weight (wt ppm). It is more preferred that the amount is at least 45 ppm. It is most preferred that the amount is at least 50 ppm.

In yet another embodiment, upon stabilization treatment, the active pollutant form is reduced by at least 5%, more preferred by at least 10%, and most preferred by at least 15%. In other words, the active pollution form is reduced from 5 ppm to 4.75 ppm, or from 5 ppm to 4.5 ppm or from 5 ppm to 4.25 ppm, respectively.

To further illustrate the present invention, a number of examples are provided below.

### EXAMPLES

### Example-1

A slurry of contaminated mud sample-A was prepared by combining a milled mud sample prepared using a roller mill and distilled water. The roller mill is a three-roller mill made of stainless steel, while the scrubbing blade is made of bronze. The roller mill used, Model S65, is from Zili Chemical and Machinery Ltd., Changzhou, China. It provides coarse milling. The mud sample has a solids content of 42.04 wt % determined at 550° C. for 2 hrs using a muffle furnace. A slurry was prepared by combining 736 grams of milled mud sample and 491 grams of distilled water. This slurry gave a solids content of 25.22 wt. %. The viscosity curve of the slurry measured at 6° C. using a Brookfield DV-II viscometer and a #3 spindle is given in FIG. 1. This slurry has a pH of 7.9 measured at 6° C.

### Example-2

A slurry was made by adding limestone powder (from Tianjin Chemical Reagent and Scientific Equipment Ltd., Tianjin, China) into the slurry obtained in Example-1. Limestone powder was added to 320 grams of the 25.22 wt % mud sample-A slurry while under mixing using a spatula. Viscosity and pH of the limestone added slurry were measured using the Brookfield DV-II viscometer and a Fisher Scientific pH meter respectively. Solids content of the slurry is calculated based on the starting solids content of the mud sample-A and the amount of limestone added. For example, after adding 40.0 grams of limestone into the 320 grams of mud sample-A slurry having solids content of 22.52%, the solids content becomes 33.53 wt %. FIG. 2 presents changes of slurry viscosity as a function of solids content.

### Example-3

A formulation was prepared by combining a slurry according to Example-1 with a milled slurry of 80% calcined limestone. The latter was prepared by combining 800 grams of calcined limestone and 200 grams of distilled water to make a paste-like material which was then milled once using the Zili roller mill Model S65 from Zili Chemical and Machinery Ltd., Changzhou, China. An amount of 250.0 grams of the 80 wt. % limestone milled slurry was added to the 1,000 grams of roller milled mud slurry-A. The resultant slurry had a solids content of 36.18 wt %. This slurry was then milled using an Eiger Mini 250 ML from Eiger Machinery Inc., Grayslake, Ill. The milling medium used was 2.00 mm zirconia microspheres. An amount of 699 grams of milling beads were loaded into the mill. Milling was conducted at 3600 RPM. Viscosity of both milled and none-milled slurries was determined. The results are given in FIG. 3. The measurements-were made using a Brookfield DV-II viscometer and the #6 spindle at 7° C.

### Example-4

A slurry of mud sample using the same sample as that used in Example-1 was prepared by combining 600 grams of mud sample and 400 grams of distilled water. This slurry contained 25.22 wt. % solids. Viscosity of the milled slurry was measured using a Brookfield DV-II viscometer and #6 spindle. This sample had a pH of 7.4 and a viscosity of 2,780 cPs measured at 10 RPM at 8° C. A portion of this slurry was used to adjust pH to a lower values using concentrated nitric acid. Changes in slurry viscosity as a function of pH are given in FIG. 4. Another portion of the slurry was adjusted to higher pH using a 10% potassium hydroxide solution. The latter experiments were conducted 16 hrs later, at this time the slurry pH was at 7.7. The results are presented in FIG. 4.

### Example-5

A slurry containing both mud sediment sample and limestone as that prepared according Example-2 was prepared. An amount of 800 grams of the slurry was made. It contained 19.22 wt % sediment and 19.04 wt % limestone. It was milled using an Eiger Mini 250 ML from Eiger Machinery Inc., Grayslake, Ill. The milling medium used was 2.00 mm zirconia microspheres. An amount of 710 grams of milling beads were loaded into the mill. Milling was conducted at 3600 RPM. The sample was milled 5 times. Viscosity of the milled slurry was measured using a Brookfield DV-II viscometer and #5 spindle. This sample had a pH of 7.4 measured at 4° C. Addition of sublimed sulfur (sulfur from Tianjin Chemicals and Reagents Supply Company Ltd, Tianjin, China), a fine powder to the slurry was made under vigorous mixing using a spatula. Viscosity measurement was measured on the sulfur added slurry. The results are presented in FIG. 5.

### Example-6

A formulation of sediment sample-E (solids content 46.05%) and aluminum chlorohydrate was prepared. First, a tri-roller milled sediment sample-E was made by milling the sediment sample once through the tri-roller mill, S65, from Zili Chemical and Machinery Ltd., Changzhou, China. 200.0 grams of the milled sediment sample-E was mixed with a diluted aluminum chlorohydrate solution prepared by adding 50.0 grams of aluminum chlorohydrate (ACH) liquid from Domen Chemicals International Company Ltd, Shanghai, China, into 386.0 grams of distilled water. Both liquid form and solid form of ACH are available from Domen Chemicals International Company Ltd. Properties of ACHs are given Table 2. This slurry had a solids content of 16.55%. It was then milled using an Eiger Mini 250 ML bead mill. The milling beads were zirconia microspheres of 2.00 mm from Tosoh Corporation, Japan. An amount of 872 grams of the milling medium were charged into the Eiger mill. After milling the slurry had very high viscosity. FIG. 6 gives the viscosity curve of the milled sample.

### Example-7

A slurry of sediment-B (mud-B) was prepared by mixing the sediment sample with distilled water. 5000.0 grams of sediment-B was added to 3333.0 grams of distilled water while under mixing using a small saw blade mixer at 350-400 RPM. Continued to mix for 10 minutes after completion of adding the Mud-B to distilled water. This slurry has a solids content of 25.22 wt %. It has a pH of 6.0 measured at 16° C. It was then milled using an Eiger Mini 250 ML bead mill for once (the entire slurry has gone through the mill once). The milling beads were zirconia microspheres of 2.00 mm from Tosoh Corporation, Japan. Viscosity of the slurry before and after milling is given in FIG. 7. Upon milling, slurry viscosity has increased substantially. This slurry was spray dried using a Niro Utility Spray Dryer from Niro A/S, Copenhagen, Denmark. Atomization of the slurry was achieved using a wheel atomizer. The wheel rotation speed was at 18,000-20,000 RPM. It was operated in the down flow/spray manner. Hot air from the liquefied petroleum gas (LPG) burner heater provided heat to dry the atomized droplets. Inlet temperature was controlled at or below 370° C. while the outlet temperature was kept at 150-160° C. This operation gave processing rate of 18-25 kg of slurry per hour. Products were collected at the bottom of the cyclone. Typical product yield was >30 wt %. No attempts were made to recover the very fines particles collected in the dust bag after the primary cyclone.

### Example-8

A slurry of sediment-B (mud-B) was prepared by mixing the sediment sample with distilled water. 4000.0 grams of sediment-B was added to 2666.7 grams of distilled water while under mixing using a small saw blade mixer at 350-400 RPM. The mixing continued for 10 more minutes after all the mud sample was added. This gave a slurry having a pH of 6.1 measured at 22° C. and a solids content of 22.58 wt %. This slurry was then milled using an Eiger Mini 250 ML bead mill. The milling beads were zirconia microspheres of 2.00 mm from Tosoh Corporation, Japan. The entire slurry was milled for once through the bead mill. Viscosity of the slurry before and after milling is given in FIG. 8. Milling has led to drastic increase in slurry viscosity. The milled slurry was spray dried using a Niro Utility Spray Dryer as used in Example-7. Atomization of the slurry was achieved using a wheel atomizer. The wheel rotation speed was at 18,000-20,000 RPM. It was operated in the down flow/spray manner. Hot air from the burner heater provided heat to dry the atomized droplets. In let temperature was controlled at or below 370° C. while the outlet temperature was kept at 150-160° C. This operation gave processing rate of 18-25 kg of slurry per hour. Products were collected at the bottom of the cyclone. Typical product yield was >30 wt %. No attempts were made to recover the very fines particles collected at the dust bag.

### Example-9

A slurry was prepared using the same sediment sample (Sediment-B) from Example-7, combined with additives for stabilization. The additives include sulfur powder, limestone, ammonium dihydrogen phosphate, calcium bentonite and Portland cement powder. The ammonium dihydrogen phosphate was obtained from Tianjin Chemical and Reagent Ltd., Tianjin, China. The Portland cement was obtained from Home Depot, Tianjin, China. Calcium bentonite was obtained from Jianping, Liaoning, China. The slurry was prepared by first making a mixture of sediment-B and distilled water, next sulfur powder was added, followed by limestone, bentonite, then cement powder, and lastly, ammonium dihydrogen phosphate. Composition of the formulation is given in Table 3. The final slurry had a solids content of 41.86% (including sulfur, sodium sulfide, ammonia dihydrogen phosphate). It was milled according to same protocol as Example-8. The milled slurry has a rather high viscosity, 35,000 cPs measured at 13° C. using a #6 Brookfield spindle at 10 RPM. Its pH was 12.4 measured at 13° C. Viscosity of the milled slurry as a function of solids content is given in FIG. 9. The milled slurry was spray dried using the same protocol as that of Example-8. The treated sample was used for determination of the extractable mercury and arsenic according to the method given in Table-1. The results are presented in Table 4.

### Example-10

A slurry was prepared using the same sediment sample (Sediment-B) from Example-7, combined with additives for stabilization. The additives include sulfur powder, limestone, ammonium hydrogen phosphate, calcium bentonite and Portland cement powder. The ammonium hydrogen phosphate was obtained from Tianjin Chemical and Reagent Ltd., Tianjin, China. The Portland cement was obtained from Home Depot, Tianjin, China. Calcium bentonite was obtained from Jianping, Liaoning, China. The slurry was prepared by first making a mixture of sediment-A and distilled water, next sulfur powder was added, followed by limestone, bentonite, then cement powder, and lastly, ammonium hydrogen phosphate. Composition of the formulation is given in Table 5. The final slurry had a solids content of 55.29% (including sulfur, sodium sulfide, ammonium hydrogen phosphate). It still has high viscosity, 15,000 cPs measured at 11° C. using a #6 Brookfield spindle at 10 RPM. However, it is much lower than that of Example-9 despite its rather high solids content. Its pH was 11.8 measured at 11° C. Viscosity of the milled slurry as a function of solids content is given in FIG. 10. The milled slurry was spray dried according to the same protocol as that of Example-8. The treated sample was used for determination of the extractable mercury and arsenic according to the method given in Table-1. The results are presented in Table 6.

Through the examples provided above, it has demonstrated that the sediment samples can be treated by size reduction and addition of stabilization agents to achieve high decontamination efficiency. Through surface modification, slurry viscosity can be altered so that low viscosity can be achieved. The treated products are in the form of spheres in the particle size range of 20-120 microns. This product form allows easy handling, transportation and storage.

TABLE 1
Extraction Procedure for Leaching Toxicity

| Parameter of Methodoloty | Code or Specification |
|---|---|
| Procedure | HJ/T299-2007 (Chinese Burea |
| | of Environmental Protection) |
| Extract Solvent | Diluted sulfuric acid and nitric |
| | acid at weight ratio of 2 to 1 in solvent |
| | grade purified water having |
| | pH = 3.20 ± 0.05 |
| Sample Quantity | 40-50 grams |
| Sample Particle Size | <9.5 mm |
| Solvent/Solid Ratio | 10 L/kg |
| Extraction Temperature | 23 ± 2° C. |
| Duration of Extraction | 18 ± 2 hrs |
| Sample Shaking | 30 ± 2 RPM |
| Sample Storage Temperature | 4° C. |

TABLE 2
Properties of Aluminum Chlorhydrate (ACH)

| | Specification | |
|---|---|---|
| Parameter | Liquid Form | Solid Form |
| Appearance | colorless liquid | white powder |
| Test | Cl in nitric acid solution | aluminum test in |
| | | hydrochloric acid |
| Solubility | in water | in diluted hydrochloric acid |
| Al | ≧12.2% (w/w) | ≧25%(w/w) |
| Alumina (Al₂O₃) | 23.0 | 47.2 |
| Salt basis (wt %) | ≧60% | ≧60% |
| Cl | ≦7.9% (w/w) | ≦18.0% (w/w) |
| [Al]/[Cl] | 1.9-2.05 | 1.9-2.05 |
| Sulfate (SO₄²⁻) | ≦250 ppm | ≦500 ppm |
| Na | ≦200 ppm | ≦400 ppm |
| As | ≦2 ppm | ≦5 ppm |
| Pb | ≦10 ppm | ≦25 ppm |
| Fe | ≦50 ppm | ≦100 ppm |
| Cr | ≦1 ppm | ≦2.5 ppm |
| Ni | ≦1 ppm | ≦5 ppm |
| pH | 4-4.4 | 4.2-4.6 |
| (15% solution) | | |

TABLE 3
Formulation Composition of Sediment-B and Additives of Example-9

| | | Solids |
|---|---|---|
| | | Concentration |
| Component | Amount (g) | (wt %) |
| Mud-B | 2000 | 20.59 |
| Portland Cement | 500 | 12.24 |
| Milled Limestone (80% paste) | 250 | 6.12 |
| Ca-Bentonite | 80 | 1.57 |
| Sublimed Sulfur | 5 | 0.12 |
| Sodium Sulfide | 20 | 0.49 |
| Ammoinium Dihydrogen | 30 | 0.73 |
| Phosphate | | |
| Distilled Water | 1200 | NA |
| Total Quantity | 4085 | 41.86 |

TABLE 4
Summary of Decontamination Treatment of Example-9

| | Before | After |
|---|---|---|
| Parameter | Treatment-A | Treatment-A |
| Total Hg (ppm) | 21.08 | 15.95 |
| Total As (ppm) | 12.32 | 8.97 |
| Extractable Hg (ppm) | 10.12 | 0.026 |
| Regulated Hg Level (ppm) | 0.2 | 0.2 |
| Extractable As (ppm) | 8.05 | 1.03 |
| Regulated As Level (ppm) | 5 | 5 |
| Decontamination Efficiency | | |
| Hg Decontamination | NA | 99.74% |
| As Decontamination | NA | 87.20% |

TABLE 5
Formulation Composition of Sediment-B and Additives of Example-10

| | | Solids |
|---|---|---|
| | | Concentration |
| Component | Amount (g) | (wt %) |
| Mud-B | 2000 | 15.90 |
| Portland Cement | 500 | 9.46 |
| Milled Limestone | 1471 | 27.82 |
| (80% paste) | | |
| Ca-Bentonite | 80 | 1.21 |
| Sublimed Sulfur | 5 | 0.12 |
| Sodium Sulfide | 2 | 0.05 |
| Ammoinium | 30 | 0.73 |
| Dihydrogen Phosphate | | |
| Distilled Water | 1200 | NA |
| Total Quantity | 5288 | 55.29 |

TABLE 6
Summary of Decontamination Treatment of Example-10

| | Before | After |
|---|---|---|
| Parameter | Treatment-B | Treatment-B |
| Total Hg (ppm) | 21.08 | 13.48 |
| Total As (ppm) | 12.32 | 8.74 |
| Extractable Hg (ppm) | 12.12 | 0.007 |
| Regulated Hg Level (ppm) | 0.2 | 0.2 |
| Extractable As (ppm) | 8.05 | 0.88 |
| Regulated As Level (ppm) | 5 | 5 |
| Decontamination Efficiency | | |
| Hg (%) | NA | 99.94% |
| As (%) | NA | 89.07% |

### DESCRIPTION OF FIGURES

FIG. 1: Viscosity of Mud-A slurry at 25.22% solids (roller mill treated once). The slurry has a pH of 7.9 at 6° C. The slurry gives a non-Newtonian viscosity behavior, shear-thinning. Even at this low solids level, it has a very high viscosity, i.e., >5000 cPs at 10 RPM. The slurry is slightly basic. For conventional soil or mud, at comparable solids content, its viscosity would be substantially lower than that of Mud-A, suggesting presence of high levels of fine colloidal particles or other viscosity inducing components.

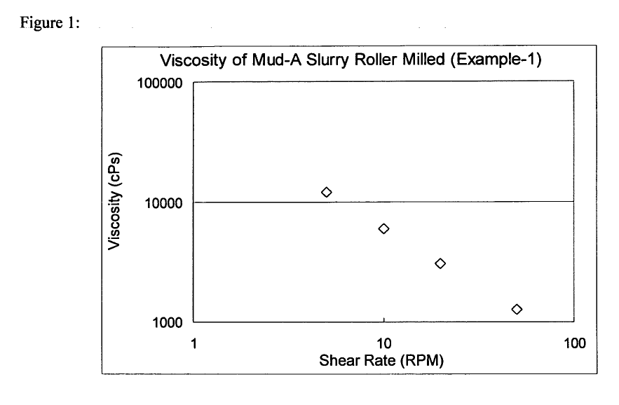

FIG. 2 Impact of adding limestone on viscosity of slurry of Sediment-A sample: starting Sediment-A slurry solids content is 25.22 wt %. Addition of limestone results in higher overall solids content, consequently high slurry viscosity. It appears that in the regions between solids content of 25% and 30%, and between 35% to 47%, viscosity increases are much steeper than the region between 30% and 35%.

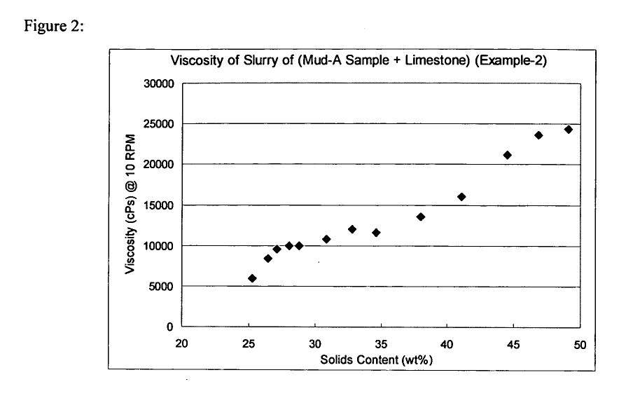

FIG. 3 Viscosity of Mud-A and Limestone slurry before and after being milled using an Eiger mill at 3600 RPM for one pass. Slurry solids content is 36.18 wt. %. The slurry has a pH of 8.2 measured at 7° C. Milling has resulted substantial increase in slurry viscosity. This is probably due to particle size reduction, smaller particles can lead to higher viscosity.

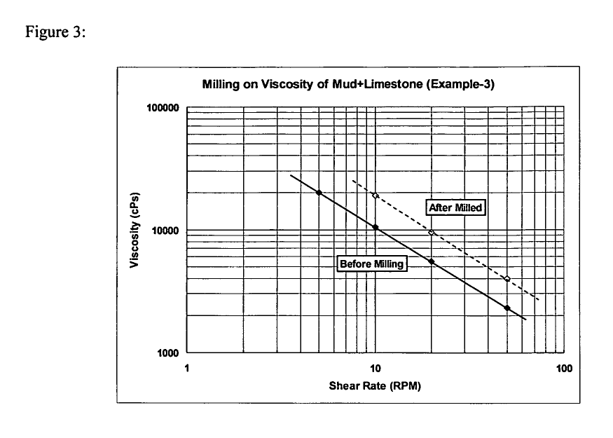

FIG. 4 Impact of pH adjustment on viscosity of sediment slurry having solids content of 25.22% using concentrated nitric acid for lowering or 10% potassium hydroxide to increase pH. It appears that the as-is made slurry that is at near neutral pH has the lowest viscosity, both lowering pH and increasing pH have resulted in substantial increase in slurry viscosity. These changes are the result of variation in electroviscolastic property of the particles. At acid pH conditions, a maximum in viscosity is reached at pH˜6.

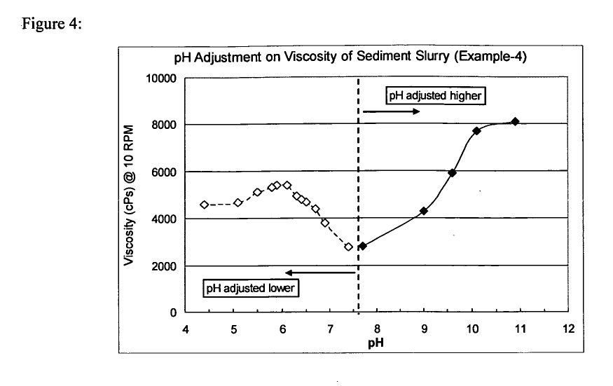

FIG. 5 Impact of sulfur addition on viscosity of sediment slurry having solids content of 38.26 wt. % after milling using Eiger Mill at 3600 RPM. Introduction of fine sulfur power into the slurry has led to steady increase in slurry viscosity. However, the effect is significantly lower than that of limestone as shown in FIG. 2.

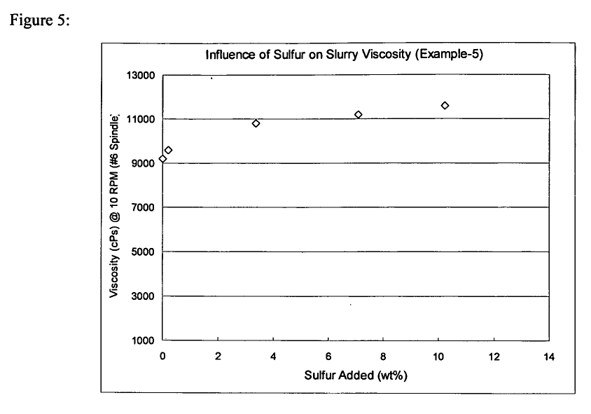

FIG. 6 Viscosity of sediment slurry formulation containing aluminum chlorohydrate (ACH) having solids content of 16.55 wt. % after milling using Eiger Mill at 3600 RPM. Again this slurry shows similar shear-thinning behavior as that the ACH-free mud sample shown in FIG. 1. It is clear that introduction of ACH into the mud slurry has resulted in significant increase in slurry viscosity, suggesting a strong interaction between the colloidal ACH particles and the mud particles.

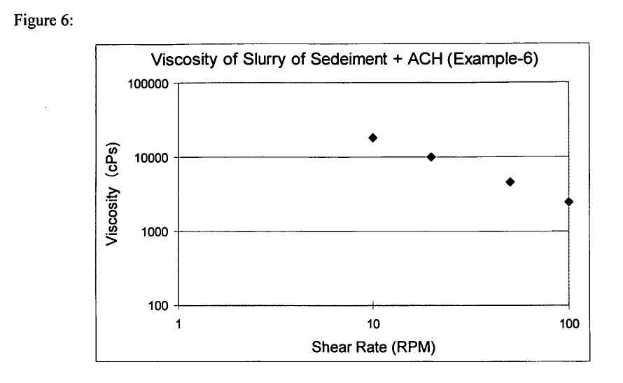

FIG. 7 Viscosity of sediment slurry having solids content of 25.22 wt. % before and after milling using Eiger Mill at 3600 RPM. Like in FIG. 3, milling has produced a slurry having much higher viscosity. It is interesting to note that not only milling has led high viscosity but also different rheological behavior as shown by the significantly different slop of the viscosity versus shear rate curve. Milled slurry has a much stronger shear-thinning behavior than the starting slurry.

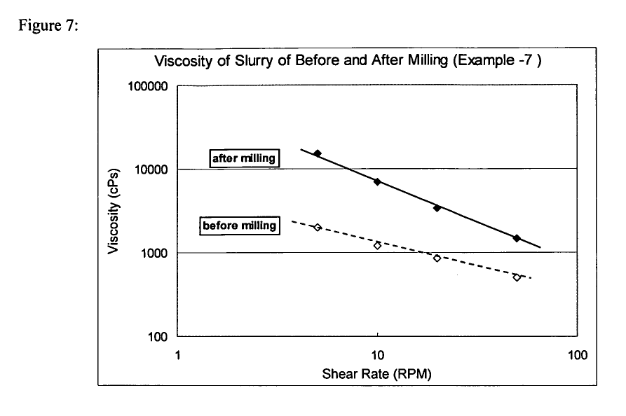

FIG. 8 Viscosity of sediment slurry having solids content of 22.58 wt. % before and after milling using Eiger Mill at 3600 RPM. At this high solids content, milling of the slurry has generated a slurry having nearly 10 times higher viscosity than the starting materials. The shear-thinning behavior before and after milling are nearly unchanged.

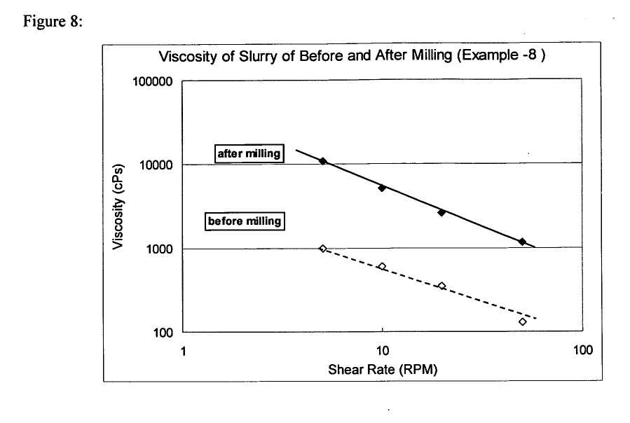

FIG. 9 Viscosity of formulation of Example-9 at different solids content. Higher solids content leads to higher slurry viscosity. The increase takes a major when solids content is above˜33%.

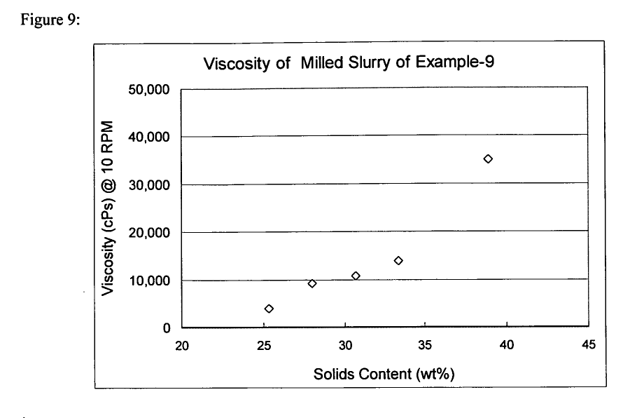

FIG. 10 Viscosity of formulation of Example-10 at different solids content. A very high viscosity is attained at solids content of 30% or higher. Within the range of 30% to 45% solids content, the trend in viscosity change as a result of solids content variation is not clear.

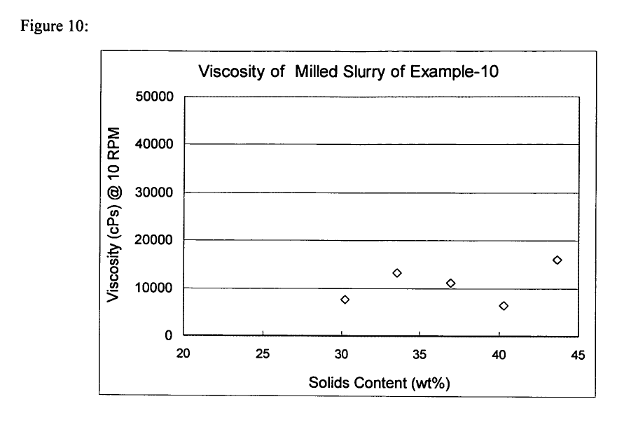

We claim:

1. A process for preparing a mixture of sediment particles for decontamination comprising the steps of:
(a) forming a slurry containing a sediment, a slurrying agent, and optionally a slurrying aid;
(b) mixing and/or milling the slurry to achieve uniform mixing and homogenization of components and to achieve particle size reduction.

2. The process of claim 1, wherein the slurry contains at least 1 wt % solids.

3. The process of claim 1, wherein the average particle size upon milling is reduced by at least 5%.

4. The process of claim 1, wherein the milling device is a high shear mill, a medium mill or combination of thereof.

5. The process of claim 1, wherein upon milling viscosity of the slurry is at least 100 cPs measured at 10 RPM at or near ambient temperature.

6. A composition for decontamination comprising of:
(a) sediment particle;
(b) slurrying agent;
(c) optionally a stabilization agent;
(d) optionally a slurring aid.

7. The composition of claim 6, wherein the slurry contains at least 1 wt % sediment particles.

8. The composition of claim 6, wherein the stabilization agent is at least 0.005 wt % of the slurry.

9. The composition of claim 6, wherein the stabilizing agent is selected from sulfur-containing, a metal oxide, a phosphate, a cement, a clay, a zeolite or a combination of thereof.

10. The composition of claim 6, wherein the slurrying aid is at least 0.005 wt % of the slurry.

11. The composition of claim 6, wherein the average particle size upon milling is reduced by at least 5%.

12. The composition of claim 6, wherein the milling device is a high shear mill, a medium mill or combination of thereof.

13. A process for treating a mixture of sediment particles, the process comprising the steps of:
(a) heating the slurry to evaporate the slurrying agent;
(b) forming a shaped particle;
(c) achieving transformation and stabilization of the contaminant form to lower the active contaminant form.

14. The process of claim 13, wherein the process results in at least 5 wt. % removal of the slurrying agent.

15. The process of claim 13, wherein a spray dryer is used.

16. The process of claim 13, wherein the drying rate is at least 50 kg of slurrying agent per hour.

17. The process of claim 13, wherein the drying temperature is at most 550° C.

18. A process for using the treated sediment particles, the process comprising the steps of:
(a) applying the treated product as a sub-surface layer for commercial or residential landscaping;
(b) using the treated product as an additive to fertilizer or insecticide or herbicide;
(c) applying the treated product as a sub-surface layer for road construction.

19. The process of claim 18, wherein the treated product is at least 5% of the landscaping area or volume.

20. The process of claim 18, wherein the treated product is at least 5% of the fertilizer or insecticide or herbicide matrix.

21. The process of claim 18, wherein the treated product is at least 5% of the sub-surface layer of the road structure.
